(19) United States
(12) Patent Application Publication
(10) Pub. No.: US 2017/0210236 A1
(43) Pub. Date: Jul. 27, 2017

(54) LOAD CONTROL OF A CHARGING STATION FOR AN ELECTRIC VEHICLE

(71) Applicant: Bender GmbH & Co. KG, Gruenberg (DE)

(72) Inventors: Winfried Moell, Laubach (DE); Frank Mehling, Ranstadt (DE)

(21) Appl. No.: 15/413,649

(22) Filed: Jan. 24, 2017

(30) Foreign Application Priority Data
Jan. 26, 2016 (DE) 10 2016 201 113.8

(51) Int. Cl. B60L 11/18; H02J 7/00; H02J 7/35

(52) U.S. Cl. CPC B60L 11/1825; H02J 7/355; H02J 7/007; H02J 7/0021; B60L 2230/20; H02J 2007/0096

(57) ABSTRACT

The invention relates to a method for controlling electric power provided at a charging station for an electric vehicle, the charging station being fed by a plant for generating renewable energy, said plant being installed close enough to the charging station that a physical and meteorological parameter value acting at the location of the plant and determining the power generated by the plant is approximately equal to the value of the parameter at the location of the charging station. The physical meteorological parameter is measured at the location of the charging station and the electric power provided by the charging station is controlled by changing a charging current as a function of the measured physical and meteorological parameter.

Furthermore, the invention relates to a charging station for an electric vehicle that implements the aforementioned method for controlling the provided electric power.

The disclosure of German Patent Application No. 10 2016 201113.8 filed Jan. 26, 2016, is incorporated herein by reference.

### TECHNICAL FIELD

The invention relates to a method for controlling electric power provided at a charging station for an electric vehicle, the charging station being fed by a plant for generating renewable energy, said plant being installed close enough to the charging station that a physical and meteorological parameter value acting at the location of the plant and determining the power generated by the plant is approximately equal to the value of the parameter at the location of the charging station.

Herein, the term control is used in a generic sense that includes a closed-loop control.

Furthermore, the invention relates to a charging station for an electric vehicle that implements the aforementioned method for controlling the provided electric power.

### BACKGROUND

As is known, the electric energy storage devices of an electric vehicle are regularly recharged at a charging station. The charging station can be located in the domestic sphere, or it can be publicly or semipublicly accessible charging stations. Said public/semipublic charging stations are usually equipped with a charge controller, which controls a charging current according to a maximum power predetermined by the charging grid infrastructure and according to a power absorbable by the electric energy storage devices in connection with an on-board charging device of the vehicle.

With the increasing number of electric vehicles, there is now the case that an ever-growing number of energy storage devices are simultaneously connected to charging stations to charge. This, in turn, leads to a fluctuating and hard-to-predict load profile with high peak loads in the supplying power grid. In particular in connection with plants for generating renewable energies, there is the risk of an electricity shortage in phases of high electricity demand, whereas a grid overload may occur in times of low demand and high electricity supply because the power fed into the grid exceeds the power demanded. In the latter case, the output of the plants for generating renewable energy can be reduced at the feed-in side by the plant operator in the course of feed-in management.

At the load side, however, no economically reasonable measures are known so far from the state of the art as to how the stability of the charging grid can be ensured in terms of a predictable and scheduled safe operation and the quality of the charging grid can be maintained with high reliability in terms supply security. While it is technically possible as well as envisaged for controlled direct-current charging in future electric vehicles that the charging current can be reduced remotely via a web interface, this manner of load control requires communicative networking of the charging stations. Networking of this kind with the aim of superordinate load management for charging stations, however, appears to be rather elaborate and has not been realized yet because of the still relatively low total (charging) power currently consumed.

With the tendency toward renewable energies, power is increasingly produced by decentralized regional solar energy or wind energy plants, the generated electricity also being consumed in the immediate vicinity of the producing plant.

In these plants, the production capacity is highly dependent on the physical and meteorological conditions at the location of the plant, such as on the solar radiation in case of photovoltaic plants or on the wind speed in case of wind power plants. On a regional perspective, the present invention is now based on the assumption that a plant of this kind is installed close enough to a charging station—to the load—that the physical and meteorological parameter determining the power generated by the plant is at least approximately equal at the location of the plant and at the location of the charging station. For example, this applies to light radiation incident at the location of the charging station and simultaneously incident on a photovoltaic plant installed in regional proximity at a distance of few kilometers.

Therefore, the object of the present invention is to control the electric power provided by the charging station in such a manner that the stability and quality of the charging grid infrastructure can be ensured with high reliability under the aforementioned condition of an approximately equal physical and meteorological parameter value.

### SUMMARY

With regard to a method, this object is attained by measuring the physical and meteorological parameter at the location of the charging station and the electric power provided by the charging station is controlled by changing a charging current as a function of the measured physical and meteorological parameter.

The basic idea of the present invention is advantageously based on adjusting the electric power provided by the charging station to the power generated by the plant for generating renewable energy so as to avoid an electricity shortage or an overload of the charging grid infrastructure through this local load management.

For this purpose, a physical and meteorological parameter determining the power generated by the plant is measured at the location of the charging station. Owing to the physical proximity of the charging station and the plant for generating renewable energy, it can be assumed that the parameter value measured at the location of the charging station also prevails at the location of the power-generating plant and can thus be used as a measure for the power generated by said plant.

As another step, the electric power provided by the charging station is controlled by changing the charging current as a function of the measured physical and meteorological parameter. Thus, peak loads are avoided by reducing the maximum possible charging current in the charging station when the parameter value indicates that the production capacity of the feeding plant decreases. Vice-versa, the maximum possible charging current can be increased when a high amount of power is fed in so as to counteract a local grid overload due to an excess amount of fed-in electricity. In this way, consumption and generation of power are kept in balance through this parameter-dependent local load control in order to ensure grid stability and thus a predictable reliable operation.

The allowance for a supply situation that changes dramatically over time because of weather-dependent fluctuations in renewable energies can be employed to offer variable electricity tariffs as a function of the power generated and to achieve a balanced load profile in view of the thus changed demand while avoiding peak loads and to thus arrive at high grid quality with high reliability of supply.

In a case where the plant for generating renewable energy is a photovoltaic plant, light radiation incident at the location of the charging station is advantageously measured as the physical and meteorological parameter.

Since the power generated by the photovoltaic plant is highly dependent on the absorbed light radiation, the latter is ideally suitable as a measurement parameter in order to adjust the charging current to the production capacity as a function of said measurement parameter.

In a further embodiment of the method, the measurement of the incident light radiation is used to assess the functioning of street lighting located in the immediate vicinity of the charging station.

As an additional benefit, the measurement of the light radiation can thus be used to test the functioning and to monitor the functioning of street lighting located in the detection range of a light sensor of the charging station. This appears sensible also because charging stations and points of street lighting (street lamps) are often installed in immediate vicinity of each other because of their shared supply lines. In connection with a transmission of information on the intensity of the received light radiation from the charging station to a central operating point, visual checking by actually driving past the lighting points thus becomes unnecessary.

In the case where the plant for generating renewable energy is a wind power plant, a wind speed acting at the location of the charging station is preferably measured as the physical and meteorological parameter.

The wind speed can be used as a measuring value in order to draw conclusions regarding the regionally fed-in power of the wind power plant and to adjust the electric power provided by the charging station to this production capacity.

In addition to the parameter-controlled load control, a time-dependent control of the charging current takes place.

Through time-dependent control, certain time segments in which a predictable production capacity is to be expected can be taken into account in addition to the parameter control.

In view of the incident light radiation, the difference between day and night can also be taken into account in this way, for instance when distinguishing whether light is sunlight or artificial light from the street lighting, or sunshine periods or strong wind periods to be expected based on weather forecasts can be taken into account during load control.

Furthermore, the physical and meteorological parameter measured at the location of the charging station is transmitted by means of a communications device.

Data transmission of the physical and meteorological parameter enables remote querying of the currently measured parameter value. The parameter values sent by the charging stations and received by an operating point can be evaluated for further processing in order to obtain a more precise picture of the regional brightness distribution for all charging stations connected to the plant for generating renewable energy and to superordinately control the load distribution.

The registered parameter values can further be used to refine weather data or to monitor and switch the street lighting.

With respect to a device, the object is attained in that the charging station has a measuring device for determining the physical and meteorological parameter and a control device that controls electric power provided by the charging station by changing a charging current as a function of the measured physical and meteorological parameter.

Implementing the method of the invention according to claim 1, the charging station comprises a measuring device for determining the physical and meteorological parameter.

The physical and meteorological parameter is detected by the measuring device and converted into an electrical control signal. A measuring sensor of the measuring device is arranged in such a manner that the measuring conditions at the location of the charging station largely correspond to the conditions at the location of the plant for generating renewable energy.

The control device adjusts the charging current as a function of the measured physical and meteorological parameter in such a manner that no peak loads occur and a load profile as balanced as possible is established.

In the case where the plant for generating renewable energy is a photovoltaic plant, the measuring device is realized as a light sensor for measuring the light radiation.

Since the light radiation is used as a measure of the power generated by the photovoltaic plant, the measuring device is realized as a light sensor.

In the case of a wind power plant, the measuring device is realized as an anemometer for measuring the wind speed.

Furthermore, the control device is realized as a time-dependent controller.

The control device extended by a time-dependent controller allows time segments with predictable production capacities to be taken into account.

In another embodiment, the charging station comprises a communication device for transmitting the measured physical and meteorological parameter value.

This embodiment allows further processing of the measured parameter value, for instance with the aim of subordinate load control of the charging stations connected to the plant for generating renewable energy or to further use the data in the course of weather observation or for switching the street lighting.

### BRIEF DESCRIPTION OF THE DRAWINGS

Other advantageous embodiment features become apparent from the following description and the drawing, which shows a preferred embodiment of the invention with the aid of examples. In the drawing:

FIG. 1: shows a charging station according to the invention during sunlight irradiation;

FIG. 2: shows the charging station according to the invention under street lighting; and

FIG. 3: shows a functional block diagram of the charging station according to the invention.

### DETAILED DESCRIPTION

FIG. 1 shows a charging station 2 according to the invention during sunlight irradiation. The incident light radiation 4 is detected as a physical and meteorological parameter by a measuring device 6 realized as a light sensor 5. The charging station has a charging socket 12 for connecting an electric vehicle 10 (FIG. 3) having a rechargeable energy storage device 8 (FIG. 3).

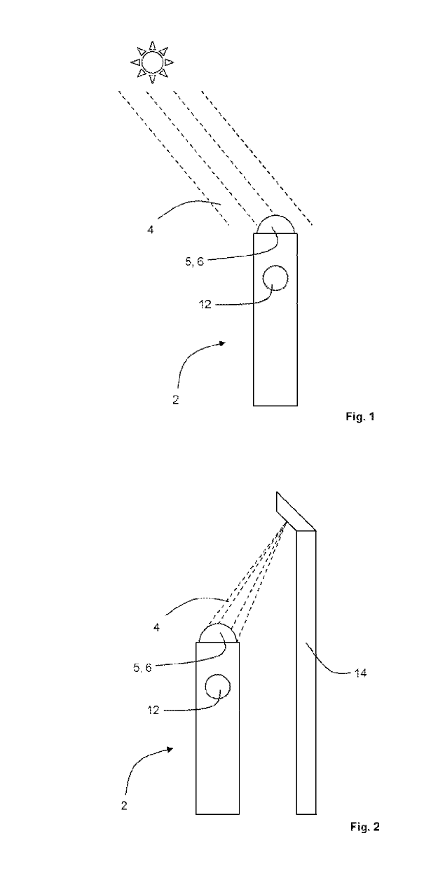

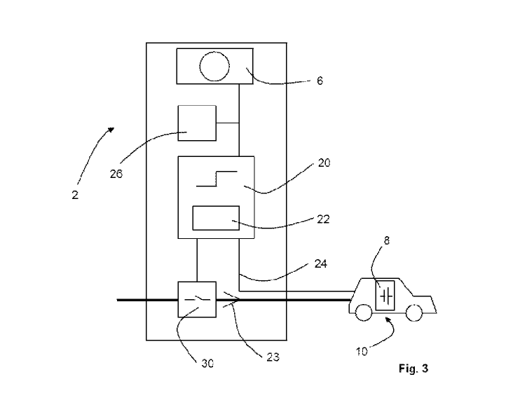

In FIG. 2, the charging station 2 according to the invention is shown in the vicinity of a street lighting 14. The light radiation 4 emitted by the street lighting 14 is received by the light sensor 6 and can be evaluated in order to assess the functioning of the street lighting 14.

FIG. 3 shows a functional block diagram of the charging station 2 according to the invention. In addition to the measuring device 6, which in correspondence to the physical and meteorological parameter to be measured is realized as a light sensor 5 (FIGS. 1, 2) or as an anemometer, for example, the charging station 2 has a charge controller 20 which comprises a control device 22. The control device 22 controls the electric power provided by the charging station 2 by changing a charging current 23 as a function of the light radiation 4 (FIGS. 1, 2) measured, for example. Control signals are exchanged between the charging station 2 and the electric vehicle 10 via a control line (control pilot) 24.

Furthermore, the charging station 2 has a communication device 26, by means of which the value of the physical and meteorological parameter can be transmitted for external further processing in a central operating point, for example.

A load relay 30 separates the supplying charging grid from the charging station 2.

1. A method for controlling electric power provided at a charging station (2) for an electric vehicle (10), the charging station (2) being fed by a plant for generating renewable energy, said plant being installed close enough to the charging station (2) that a physical and meteorological parameter value acting at the location of the plant and determining the power generated by the plant is approximately equal to the value of the parameter at the location of the charging station (2), the method comprising the steps of:
measuring the physical and meteorological parameter at the location of the charging station (2),
controlling the electric power provided by the charging station (2) by changing a charging current (23) as a function of the measured physical and meteorological parameter.

2. The method according to claim 1,
characterized in that
the plant for generating renewable energy is a photovoltaic plant and a light radiation (4) incident at the location of the charging station (2) is measured as the physical and meteorological parameter.

3. The method according to claim 2,
characterized in that
the measurement of the incident light radiation (4) is used to assess the functioning of street lighting located in the immediate vicinity of the charging station.

4. The method according to claim 1,
characterized in that
the plant for generating renewable energy is a wind power plant and a wind speed acting at the location of the charging station (2) is measured as the physical and meteorological parameter.

5. The method according to claim 1,
characterized in that
the charging current (23) is controlled time-dependently.

6. The method according to claim 1,
characterized in that
the physical and meteorological parameter measured at the location of the charging station (2) is transmitted by means of a communication device (26).

7. A charging station (2) for an electric vehicle (10), the charging station being fed by a plant for generating renewable energy, said plant being installed close enough to the charging station that a physical and meteorological parameter value acting at the location of the plant and determining the power generated by the plant is approximately equal to the value of the parameter at the location of the charging station (2),
characterized by
a measuring device (6) for determining the physical and meteorological parameter and a control device (22) that controls the electric power provided by the charging station (2) by changing a charging current (23) as a function of the measured physical and meteorological parameter.

8. The charging station according to claim 7,
characterized in that
the plant for generating renewable energy is a photovoltaic plant and the measuring device (6) is realized as a light sensor (5) for measuring the light radiation (4).

9. The charging station according to claim 7,
characterized in that
the plant for generating renewable energy is a wind power plant and the measuring device (6) is realized as an anemometer for measuring the wind speed.

10. The charging station according to claim 7,
characterized in that
the control device (22) is realized as a time-dependent controller.

11. The charging station according to claim 7,
characterized by
a communication device (26) for transmitting the measured physical and meteorological parameter value.

12. A charging station for an electric vehicle, the charging station being fed by a plant for generating renewable energy, said plant being installed such that a physical and meteorological parameter value acting at the location of the plant and determining the power generated by the plant is approximately equal to the value of the parameter at the location of the charging station, comprising a sensor for sensing the physical and meteorological parameter and a controller for controlling the electric power provided by the charging station by changing a charging current as a function of the measured physical and meteorological parameter.
